(19) United States
(12) Patent Application Publication
(10) Pub. No.: US 2020/0025018 A1
(43) Pub. Date: Jan. 23, 2020

(54) MODULE FOR A TURBOMACHINE

(71) Applicant: MTU Aero Engines AG, München (DE)

(72) Inventor: Markus Schlemmer, Mainburg / Sandelzhausen (DE)

(73) Assignee: MTU Aero Engines AG, München (DE)

(21) Appl. No.: 16/204,247

(22) Filed: Nov. 29, 2018

(30) Foreign Application Priority Data
Dec. 1, 2017 (DE) 10 2017 221 660.3

(51) Int. Cl. F01D 11/12; F01D 9/04

(52) U.S. Cl. CPC F01D 11/127; F01D 9/041; F05D 2240/55; F05D 2300/17; F05D 2260/231; F05D 2220/323

(57) ABSTRACT

The present invention relates to a module for a turbomachine. The guide vane arrangement has a guide vane, an inner platform, and a first guide pin, the guide vane is arranged radially outside on the inner platform and the first guide pin is arranged radially inside on the inner platform, and wherein the seal carrier is arranged radially inside the inner platform and forms an uptake, which is open radially outward, the first guide pin of the guide vane arrangement being arranged in the uptake. In the uptake, a slide body is arranged, on which the first guide pin of the guide vane arrangement, with respect to a rotation around the longitudinal axis of the module, finds a contact and is guided in a radially movable manner in this contact. The slide body is formed in one piece with a wall of the seal carrier, which axially bounds the uptake.

### BACKGROUND OF THE INVENTION

### Technical Field

The present invention relates to a module for a turbomachine.

### Prior Art

The turbomachine may involve, for example, a jet engine, e.g., a turbofan engine. Functionally, turbomachines are divided into compressors, combustion chambers, and turbines. Generally, in the case of the jet engine, aspirated air is compressed by the compressor and burned in the downstream combustion chamber with fuel mixed in. The hot gas that arises, a mixture of combustion gases and air, flows through the downstream turbine and is thereby expanded. In this case, the turbine withdraws the hot gas, proportionally also as energy, in order to drive the compressor. The turbine and the compressor are usually each constructed with multiple stages, wherein, in each case, a stage has a ring of guide vanes and a ring of rotating blades. In the case of the compressor, the rotating blade ring is arranged each time downstream of the guide vane ring.

The present invention has as a subject a module comprising a guide vane arrangement and a seal carrier. In addition to the one or more guide vanes arranged on an inner platform, the guide vane arrangement has guide pins that are arranged radially opposite the guide vanes inside on the inner platform. The one or more guide pins form a so-called spoke centering and, for this purpose, engage in an uptake that opens radially outward for the seal carrier. Further, a slide body is arranged in this uptake, this slide body forming a contact for the one or more guide pins relative to the direction of rotation. In the direction of rotation, which refers to a rotation around the longitudinal axis of the module or of the turbomachine, considerable mechanical forces are transferred by way of the guide vanes, and the slide body is stressed correspondingly. Therefore, currently, a special slide body that withstands these high mechanical stresses is used and is fastened with a rivet.

### SUMMARY OF THE INVENTION

The present invention is based on the technical problem of providing a particularly advantageous module for a turbomachine.

This problem is solved according to the invention by a module of the present invention, in which the slide body is designed in one piece with a wall of the seal carrier that axially bounds the uptake with the guide pin therein. The one-piece configuration is advantageous in this regard, since the slide body need not be fastened separately as an integral part; in concrete terms, no riveting is required. In the prior art, the slide body is placed between two walls of the seal carrier that together axially bound the uptake and is fastened by a rivet that penetrates through these walls and the slide body. In this case, the slide body needs to be somewhat under-dimensioned, so that it can generally be moved between the walls into the mounting position. In the riveting itself, the walls are pressed together prior to closing the rivet. The inventor has now determined that the rivet is loaded with a pre-stress thereby, which is based on the spring effect after the riveting tool has been removed, and this pre-stress can lead, in the worst case, to a failure of the rivet, initially or over the period of use. This cleaving problem can be resolved by the one-piece configuration.

Preferred embodiments are found in the dependent claims and the overall disclosure, wherein, in the presentation of the features, a distinction is not always made individually between the module, a corresponding compressor, or the turbomachine. The disclosure is to be read with respect to all of these categories, in particular also to corresponding applications.

As is clear in the details that follow, the uptake is usually axially bounded by two walls of the seal carrier, which form a U profile in an axial section. With respect to the radial depth of this U profile, the slide body is arranged essentially in the center according to the prior art; thus, a free space remains radially between the slide body and the base of the profile. As the example of embodiment also illustrates, the slide body extends in the present case, in contrast, preferably down to the base of the profile. If, for example, the uptake is introduced from radially outside in a material-removing manner, e.g., by milling or piercing, an appropriate shape may also be necessary. A material removal is then hardly possible radially underneath the slide body due to the lack of accessibility. In comparison to the prior art with the free space therein, a certain disadvantage must therefore be taken into the bargain, that is, a heavier weight as a consequence of the larger volume of the slide body. Although this may translate into a somewhat increased fuel consumption, for example, in the case of an aircraft engine, considered overall, the increased reliability with the subject of the invention is more important.

In general, in the scope of this disclosure, “axial” refers to the longitudinal axis of the module, thus the longitudinal axis of the compressor or of the turbomachine. This longitudinal axis can coincide, for example, with an axis of rotation, in order to rotate the rotating blades associated with the guide vane arrangement during operation. “Radial” relates to the radial directions perpendicular thereto, pointing away from the longitudinal axis, and “rotation” or the “direction of rotation” refers to a rotation around the longitudinal axis. In the case of an “axial section”, the longitudinal axis lies in the sectional plane.

Further, in the scope of this disclosure, unless expressly indicated otherwise, “a” and “one” are to be read as the indefinite article and thus also are always to be read as “at least one”. The guide vane arrangement can be provided, for example, as a multiple arrangement; thus, a plurality of guide vanes can be arranged radially outside on the inner platform and follow one another circumferentially. The guide vane arrangement forms the stage jointly with another or other guide vane arrangement(s) that follow one another circumferentially. Preferably, all guide vane arrangements of the stage are guided on a slide body formed in one piece with the wall of the seal carrier.

As a consequence of the configuration “in one piece” with one another, the slide body and the seal carrier wall cannot be separated from one another in a non-destructive manner; therefore, they can only be separated from one another with at least partial destruction of the slide body and/or the seal carrier wall or a connecting layer therebetween. In general, a one-piece formation is also conceivable by a material-bonded or cohesive connection of the slide body with the seal carrier wall, in particular, by a welding, e.g., by friction welding.

In the preferred embodiment, the slide body is designed monolithically with the seal carrier wall. The two are thus shaped together, for example, in the same manufacturing process, e.g., in a casting process or in an additive construction. The slide body and the seal carrier wall, however, can also be worked out of a solid material by corresponding removal of material, e.g., by milling or piercing, etc. A transition region between slide body and seal carrier wall can be free of boundaries between different materials or materials of different manufacturing history as a consequence of the “monolithic” embodiment. The monolithic embodiment can be particularly robust, for example.

In a preferred embodiment, at least one surface region of the slide body that forms the contact for the guide pins is provided with a coating. Although the slide body is not provided from a material that is more solid when compared with the seal carrier wall, unlike the case in the prior art, the mechanical strength can be advantageously increased with the coating.

In a preferred embodiment, an inner wall surface of the seal carrier wall is provided with a coating, at least in a region around the slide body, which can help increase the strength or capacity to withstand load in this mechanically stressed region. The inner wall surface delimits the uptake axially. Preferably, the slide body itself and the inner wall surface are coated in regions. That is, if, in the case of the material-removing manufacture, the slide body with a fillet can transition into the inner wall surface, said surface is then preferably coated.

A highly heat-resistant nickel alloy is provided as a coating in a preferred embodiment. Copper can be alloyed to the nickel, for example.

In a preferred embodiment, the first guide pin, together with a second guide pin, engage the slide body with respect to the direction of rotation. The slide body is thus held circumferentially between the guide pins (however, a piece can still be displaced far radially), for which reason, this arrangement is also called Tang (“forceps”). The two guide pins find their respective contact on lateral surfaces of the slide body that are circumferentially opposite one another; this arrangement represents a spoke centering.

In a preferred embodiment, as already mentioned, the seal carrier wall forms a U profile with another seal carrier wall, when considered in an axial section. The seal carrier walls, which are also called partition walls, have a radial surface extent, in the direction of rotation; their respective thickness dimension is taken axially. Preferably, the seal carrier walls lie parallel to one another and each is perpendicular to the longitudinal axis (with respect to their surface extent).

In a preferred embodiment, the slide body is formed in one piece with both seal carrier walls, preferably monolithic in each case. However, this is not absolutely necessary in general: the slide body could also be provided in one piece only with one of the seal carrier walls; the other seal carrier wall could then be produced as a metal sheet, for example. The one-piece/monolithic construction, preferably with both seal carrier walls, can be obtained, for example, in the case of a material-removing manufacture, starting from a disk: from radially outside, from the edge of the disk, an axially central region will be removed, whereby the uptake is formed and the seal carrier walls remain. In this case, the slide body also remains; therefore, no material is removed in the corresponding region.

In a preferred embodiment, the slide body extends radially inward, down to the base of the U profile; see also the above remarks. A correspondingly lengthwise extended slide body can also be advantageous with respect to mechanical stress, since a force that is introduced from the one or more guide pins and that is distributed onto a larger surface means a lower pressure and thus less stress.

In the case of one preferred embodiment, a rivet passes through the two walls and the slide body. On an outer wall surface, which is turned away from the uptake, of at least one of the two seal carrier walls, preferably on both seal carrier walls, the rivet holds a seal (on the outer wall surface in each case). The rivet thus serves for fastening the seal, not for fastening the slide body, for which reason the initially described cleavage problem does not occur, or at least does not occur to that extent.

In a preferred embodiment, the seal is a fish mouth seal. Said seal can be formed, in particular, from S-shaped or L-shaped sheet metal parts that extend out away from the respective outer wall surface of the corresponding seal carrier wall with an axial extent, at least proportionally. The fish mouth seals may thus have a radial overlap with axial flanges of the upstream or downstream rotating blade arrangements.

In the case of a preferred embodiment, the seal carrier bears a sealing element, preferably a honeycomb seal, radially inside. The arrangement of seal carrier ring, fish mouth seal, and spoke centering by the slide body is also called Static Inner Air Seal (SIAS).

The invention also relates to a compressor having a module as disclosed in the present document. Further, the invention also relates to a turbomachine having a corresponding compressor or a presently described module.

### BRIEF DESCRIPTION OF THE DRAWINGS

The invention will be explained in more detail in the following on the basis of an example of embodiment, wherein the individual features in the scope of the independent claims can also be essential to the invention in another combination, and wherein also no distinction is made individually between the different claim categories.

Taken individually,

FIG. 1 shows a jet engine in an axial section;

FIG. 2 shows, as part of a compressor stage, a guide vane arrangement with a mounting on a seal carrier, again in an axial section;

FIG. 3a shows, in a sectioned axial view, a slide body according to the prior art as part of the mounting according to FIG. 2;

FIG. 3b shows, in a sectioned axial view, a slide body according to the invention as part of the mounting according to FIG. 2.

### DESCRIPTION OF THE INVENTION

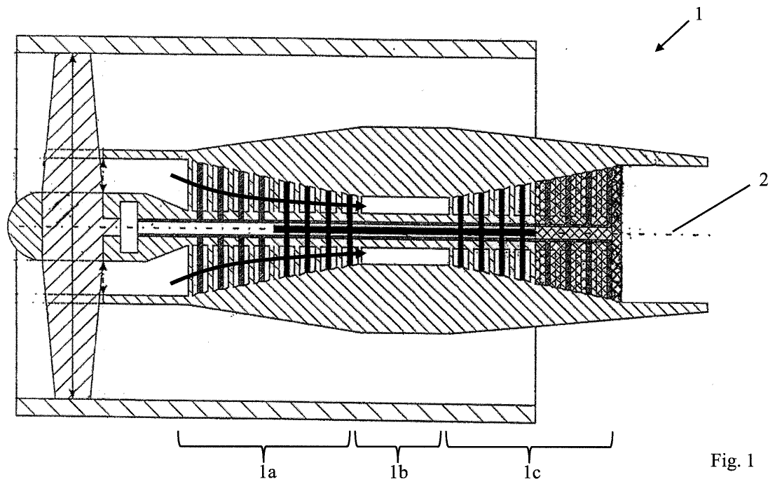

FIG. 1 shows a turbomachine 1 in a schematic view, concretely a jet engine. The turbomachine 1 is functionally divided into compressor 1a, combustion chamber 1b, and turbine 1c. In this case, both the compressor 1a as well as the turbine 1c are each constructed of several stages; each stage is composed of a guide vane ring and a rotating blade ring. In the case of turbine 1c, the rotating blade ring is arranged in each case downstream of the associated guide vane ring. In operation, the rotating blades rotate around the longitudinal axis 2.

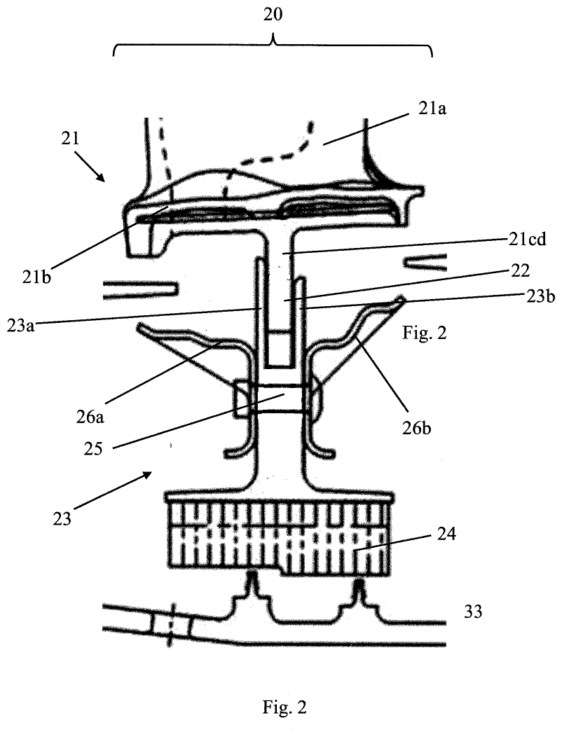

FIG. 2 shows as module 20 an excerpt of the compressor 1a, again in an axial section. In concrete terms, a guide vane arrangement 21 comprising a guide vane 21a, an inner platform 21b, as well as a first and a second guide pin 21c,d can be recognized. The guide vane 21a is arranged radially outside on the inner platform 21b, the guide pins 21c, d are arranged radially inside. The guide pins 21c,d extend radially inward into an uptake 22, which the seal carrier 23 forms. Concretely, the uptake 22 is axially bound between a front wall 23a and a rear wall 23b of the seal carrier 23; the two walls 23a,b of the seal carrier 23 form a U profile open radially outward in the axial section. Radially inside, the seal carrier 23 bears a sealing element 24, namely a honeycomb seal.

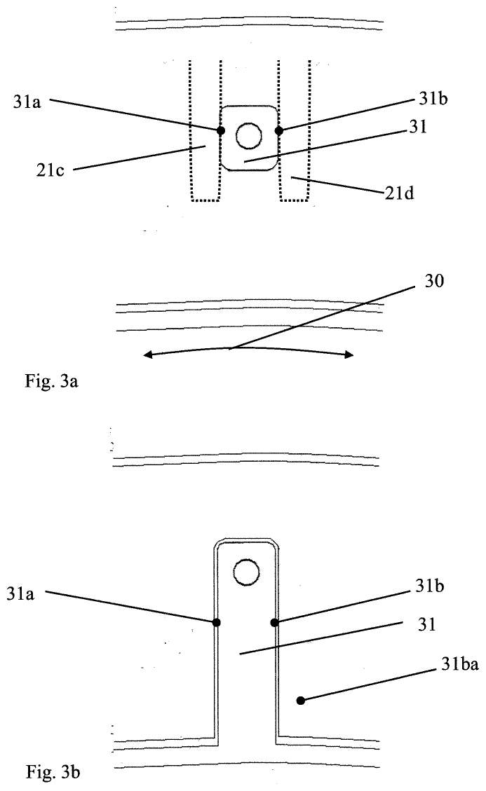

The guide pins 21c,d are held in position axially between the walls 23a,b; in this case, however, they can still move radially and thus are not clamped. In further detail, the sectional plane of the axial section according to FIG. 2 lies circumferentially between the two guide pins 21c,d. In the following, therefore, reference is also additionally made to FIG. 3a, from which it can be seen how the guide pins 21c,d (indicated by dotted lines) jointly enclose a slide body 31 with respect to a direction of rotation 30. The first guide pin 21c has a contact on a lateral surface 31a of the slide body 31 on the rotation side; the second guide pin 21d has a contact on the rotationally opposite side surface 31b. This also forms an arrangement designated as Tang, the so-called spoke centering, which still permits a certain radial displacement (in order to compensate for thermally induced expansions of various magnitude during operation). The guide pins 21c,d run radially outward together, fork-shaped to a certain extent, which can be seen in the section according to FIG. 2.

FIG. 3a shows a sectioned axial view; the sectional plane lies perpendicular to the longitudinal axis 2 and divides the uptake 22 centrally. The front wall 23a lies outside the plane of the drawing; the view falls on the rear wall 23b of the seal carrier 23. FIG. 3a shows a variant according to the prior art, in which the slide body 31 and the walls 23a,b of the seal carrier 23 are made of multiple parts and are fastened by a rivet (not shown in FIG. 3a).

FIG. 3b shows a slide body 31 according to the invention, which is formed in one piece with the walls 23a,b of the seal carrier 23. Concretely, the slide body 31 transitions monolithically into the two walls 23a,b; the manufacture is conducted in a material-removing manner in the present case. For this purpose, starting from a disk, the uptake 22 is thus introduced from the top in FIG. 3b, from radially outside, by milling or piercing. In this case, the slide body 31 remains upright.

The guide pins 21c,d are not shown in FIG. 3b for the sake of clarity, but engage the slide body analogously to FIG. 3a. Based on the slide body 31 that is longitudinally extended to the base 23c of the profile, the contact surface between the guide pins 21c,d and the slide body is larger, which reduces the mechanical stress. In addition, for mechanical strengthening, there is an inner wall surface 23ba around the slide body 31, and also the lateral surfaces 31a,b of the slide body 31 itself are coated with a highly heat-resistant nickel alloy.

Based on the one-piece or monolithic configuration, the slide body 31 does not need to be fastened with a rivet, which, in the present assembly, would produce a rivet loaded with a high pre-stress. According to the prior art, namely, a certain axial gap is necessary between the slide body 31 and the walls 23a,b; see also the remarks in further detail in the introduction to the description. The embodiment according to the invention can thus have advantages with respect to service life and reliability.

As can be seen from a juxtaposition of FIGS. 2 and 3b, however, a rivet 25 that holds a fish mouth seal 26a,b, namely, at each of the two walls 23a,b, preferably pushes through the slide body 31. Because the slide body 31 is formed in one piece with the walls 23a,b, however, the rivet 25 is clearly less stressed.

It would be appreciated by those skilled in the art that various changes and modifications can be made to the illustrated embodiments without departing from the spirit of the present invention. All such modifications and changes are intended to be covered by the appended claims.

What is claimed is:

1. A module for a turbomachine, comprising:
a guide vane arrangement; and
a seal carrier;
wherein the guide vane arrangement has a guide vane, an inner platform, and a first guide pin, wherein, in each case referred to a longitudinal axis of the module, the guide vane is arranged radially outside on the inner platform, and the first guide pin is arranged radially inside on the inner platform;
wherein the seal carrier is arranged radially inside the inner platform and forms an uptake, which is open radially outward, the first guide pin of the guide vane arrangement being arranged in said uptake;
wherein, in the uptake, a slide body is arranged, on which the first guide pin of the guide vane arrangement, with respect to a rotation around the longitudinal axis of the module, finds a contact and is guided in a radially movable manner in this contact; and
wherein the slide body is formed in one piece with a wall of the seal carrier, which axially bounds the uptake.

2. The module according to claim 1, in which the slide body is monolithically formed with the wall axially bounding the uptake of the seal carrier.

3. The module according to claim 1, in which at least a surface region of the slide body is provided with a coating, this region forming the contact for the first guide pin of the guide vane arrangement.

4. The module according to claim 1, wherein an inner surface of the wall of the seal carrier, this surface facing the uptake, is provided with a coating, at least in a region around the slide body.

5. The module according to claim 3, in which a highly heat-resistant nickel alloy forms the coating.

6. The module according to claim 1, wherein a second guide pin is arranged radially inside on the inner platform, and said second guide pin, together with the first guide pin, is arranged in the uptake of the seal carrier, wherein the second guide pin also finds a contact on the slide body, and the slide body is arranged, with respect to the rotation, between the first guide pin and the second guide pin.

7. The module according to claim 1, wherein the wall of the seal carrier, together with another wall of the seal carrier, forms the uptake that has the shape of a U profile when considered in an axial section.

8. The module according to claim 7, wherein the slide body is formed in one piece with the other wall.

9. The module according to claim 7, wherein the slide body extends radially inward down to a base of the U profile.

10. The module according to claim 7, wherein a rivet pushes through both walls and the slide body, and holds a seal on at least one of the two walls, concretely on the outer wall surface thereof, which is turned away from the uptake.

11. The module according to claim 10, wherein the seal is a fish mouth seal.

12. The module according to claim 1, wherein the seal carrier bears a sealing element radially inside.

13. The module according to claim 12, wherein the sealing element is a honeycomb seal.

14. The module according to claim 1, wherein the module is configured and arranged in a compressor for a turbomachine.

15. The module according to claim 4, in which a highly heat-resistant nickel alloy forms the coating.

16. The module according to claim 7, wherein the slide body is formed monolithically therewith.
